(19) United States
(12) Patent Application Publication
(10) Pub. No.: US 2011/0067644 A1
(43) Pub. Date: Mar. 24, 2011

(54) PET GROOMING TOOL

(75) Inventor: Sascha PROCHASKA, Secaucus, NJ (US)

(73) Assignee: The Hartz Mountain Corporation, Secaucus, NJ (US)

(21) Appl. No.: 12/887,147

(22) Filed: Sep. 21, 2010

Related U.S. Application Data
(60) Provisional application No. 61/244,517, filed on Sep. 22, 2009.

(51) Int. Cl. A01K 13/00

(52) U.S. Cl. 119/628; 119/633

(57) ABSTRACT

A grooming tool for pets or animals. The tool can include a handle portion and a grooming portion. The grooming portion preferably includes a plurality of tines arranged in first and second rows such that the first row of tines is vertically separated from the second row of tines. In addition, each of the first and second row of tines preferably includes alternating first and second tines, wherein the first tines have a longer length than the second tines. Moreover, preferably, the longer first tines and the shorter second tines in the first row of tines alternate compared to the longer first tines and the shorter second tines in the second row of tines. The first and second row of tines may also include different radii of curvatures, tapered outer diameters, etc. Moreover, in another preferred embodiment of the grooming tool, the tool may including a raking portion to dislodge the hair or fur from the grooming portion.

### CROSS-REFERENCE TO RELATED APPLICATIONS

This application claims priority to U.S. Provisional Patent Application No. 61/244,517, filed Sep. 22, 2009, entitled “Pet Grooming Tool” the contents of which are hereby incorporated herein by reference.

### BACKGROUND OF THE INVENTION

Animal grooming has become increasingly important for many pet owners. Many tools exist that perform the function of removing dead or loose hair from the coat of an animal such as a cat or dog. Such tools typically involve a handle portion for the user to hold the tool to which a series of blades, comb tines or fine metal or plastic matrix of wire (collectively referred to herein as tines) are attached. The user, through a repeated action of the tool on or through the animal's fur or hair mechanically dislodges and removes any loose hair from the animal coat.

The above mentioned tools can be quite effective at dislodging the loose hair but have been found to be unsuitable at capturing or collecting the hair once it has become dislodged. Such tools typically allow the hair to fall to the floor, creating a new task for the user to now collect the hair from the floor with an auxiliary device such as a vacuum cleaner. This task complicates the grooming process and makes it both cumbersome for the user and the pet.

Accordingly, there is a need for improved hair or fur grooming tool which can be easily and effectively cleaned and manage the refuse that is dislodged as part of the grooming process.

### SUMMARY OF THE INVENTION

The invention relates generally to a fur or hair grooming tool, particularly for pets or other animals. In a first preferred embodiment of the invention, the grooming tool includes a handle portion and a grooming portion coupled to an end of the handle portion. The grooming portion includes a plurality of tines arranged in first and second rows such that the first row of tines is vertically separated or offset from the second row of tines by a distance X.

The tines in the first row of tines preferably have a first radius of curvature while the tines in the second row of tines preferably have a second radius of curvature, the second radius of curvature being different than the first radius of curvature. Additionally or alternatively, each of the first and second rows of tines preferably include alternating tines of varying lengths. That is, for example, each of the first and second rows of tines can include alternating first and second tines, wherein the first tines have a first length and the second tines have a second length, the second length being different that the first length. Moreover, preferably, the first and second tines in the first row alternate with respect to the first and second tines in the second row. As such, the grooming portion preferably includes first and second rows of tines vertically spaced from one another wherein the first and second row of tines each include alternating first and second tines and wherein the first tines in the first row alternate with the first tines in the second row and the second tines in the first row alternate with the second tines in the second row. The tines may also include a tapered outer diameter and/or a hemispherical tip.

In another preferred embodiment of the invention, the grooming tool, includes an upper portion and a lower portion. The upper portion includes a handle portion and a raking portion. The lower portion includes a receiving portion and a grooming portion, which includes a plurality of tines. In use, with the grooming tool assembled, the handle portion and the raking portion preferably mate with the receiving portion to create a single tool that allows a user to brush or comb an animal using the grooming portion. When the user desires to dislodge the hair or fur from the grooming portion, the raking portion is disconnected from the receiving portion and is pushed by the user over the grooming portion to dislodge any hair or fur that has accumulated in the grooming portion.

The tines are constructed and arranged to have a selected geometry that has the capacity to efficiently remove as well as hold large quantities of hair by compressing along the length of the tine array. The result is a grooming instrument having the capacity to hold and store a large amount of hair. One can remove and capture hair from an animal's coat in a wholesale fashion by virtue of the tool's design.

### BRIEF DESCRIPTION OF THE DRAWINGS

The particular features and advantages of the present invention can be better understood by reference to the following drawings, wherein like reference numerals represent like elements. The drawings are merely exemplary to illustrate certain features that may be used singularly or in combination with other features and the present invention should not be limited to the embodiments shown. In the drawings:

FIG. 1 is a perspective view of a grooming tool in accordance with a preferred embodiment of the invention;

FIG. 2 is a perspective view of the grooming tool illustrated in FIG. 1, with a raking portion of the grooming tool depicted in a detached position;

FIG. 3 is a side view of the grooming tool illustrated in FIG. 1;

FIG. 4 is a top view of the grooming tool illustrated in FIG. 1;

FIG. 5 is a rear view of the grooming tool illustrated in FIG. 1;

FIG. 6 is a frontal view of the grooming tool illustrated in FIG. 1;

FIG. 7 is a detailed view of the tines of the grooming tool illustrated in FIG. 6;

FIG. 8 is a perspective view of a grooming tool in accordance with another preferred embodiment of the invention;

FIG. 9 is a perspective view of the grooming tool illustrated in FIG. 8, with a raking portion of the grooming tool depicted in an unclipped position;

FIG. 10 is a side view of the grooming tool illustrated in FIG. 8;

FIG. 11 is a top view of the grooming tool illustrated in FIG. 8;

FIG. 12 is a rear view of the grooming tool illustrated in FIG. 8;

FIG. 13 is a frontal view of the grooming tool illustrated in FIG. 8;

FIG. 14 is a detailed view of the tines portion of the grooming tool illustrated in FIG. 13;

FIG. 15 is a perspective view of a grooming tool in accordance with another preferred embodiment of the invention;

FIG. 16 is a top view of the grooming tool illustrated in FIG. 15;

FIG. 17 is a bottom view of the grooming tool illustrated in FIG. 15;

FIG. 18 is a side view of the grooming tool illustrated in FIG. 15;

FIG. 19 is a rear view of the grooming tool illustrated in FIG. 15;

FIG. 20 is a frontal view of the grooming tool illustrated in FIG. 15;

FIG. 21 is a detailed view of the tines of the grooming tool illustrated in FIG. 18;

FIG. 22 is a detailed view of the tines of the grooming tool illustrated in FIG. 17; and

FIG. 23 is a detailed perspective view of the tines of the grooming tool illustrated in FIG. 22.

### DETAILED DESCRIPTION OF THE INVENTION

The present invention relates to a pet grooming tool which can be easily and effectively cleaned and manage the refuse that is dislodged as part of the grooming process. In the following description, for purposes of explanation, certain dimensions, materials and configurations are set forth in order to provide a thorough understanding of the invention.

Certain embodiments will now be discussed with reference to the aforementioned figures, wherein like referenced numerals will refer to like components. It should be noted that references in the specification to phrases such as “one embodiment” or “an embodiment” means that a particular feature, structure or characteristic described in connection with the embodiment is included in at least one embodiment. The appearances or phrases such as “in one embodiment” in various places in the specification are not necessarily, but can be, referring to the same embodiment.

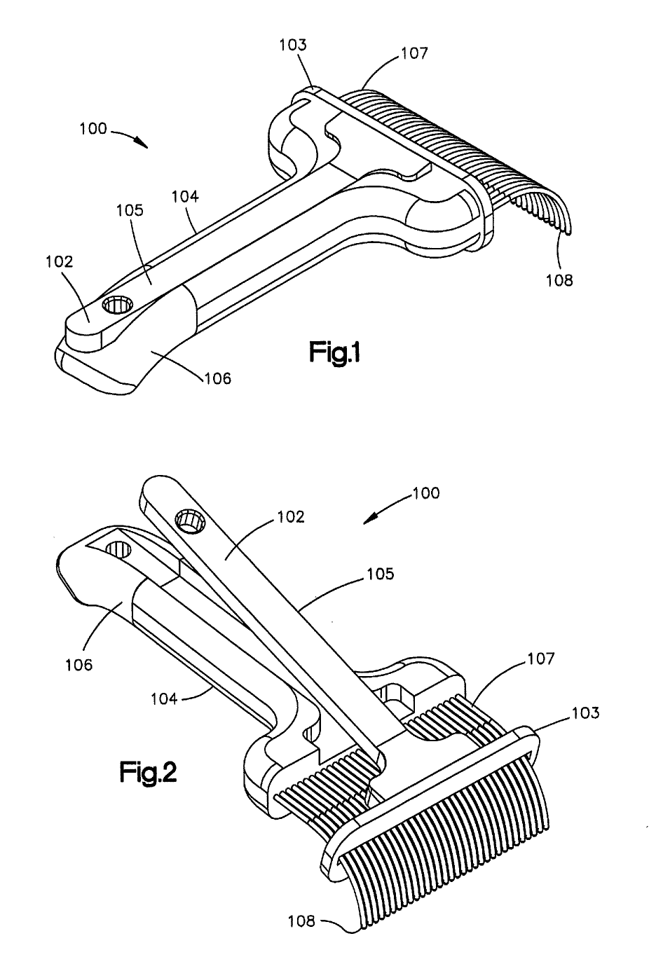

FIGS. 1 thru 7 show a first preferred embodiment of a grooming tool 100 and the components thereof in accordance with an embodiment of the present invention which is most preferably used for grooming a dog. Referring to FIGS. 1 and 2, grooming tool 100 includes an upper portion 102 and a lower portion 104. Upper portion 102 includes a handle portion 105 and a raking portion 103 that is generally perpendicular to handle portion 105. Lower portion 104 includes a receiving portion 106 and a grooming portion 107. When grooming tool 100 is assembled (as illustrated in FIG. 1), handle portion 105 and raking portion 103 mate with receiving portion 106 to create a single tool that allows a user to brush or comb an animal with grooming portion 107. Preferably, raking portion 103 clips or otherwise attaches to receiving portion 106 when raking portion 103 is not being used to clear hair or fur from grooming portion 107, as will be discussed in more detail below. In a preferred embodiment of the invention, handle portion 105 and receiving portion 106 are made of a polypropylene material. Other materials, as can be appreciated by one with ordinary skill in the art, can be used as well.

In practice when a user wishes to groom an animal using grooming tool 100, the user grasps grooming tool 100 by handle portion 105 which is mated with receiving portion 106. The user can then rake the animal's hair or fur by combing or brushing grooming portion 107 through the hair or fur of the animal to be groomed. Because of the shape and dimensions of the grooming portion 107, as will be discussed in more detail below, the hair that is combed becomes lodged within tines 108 of grooming portion 107. Once the user wants to dislodge the hair or fur from the tines 108, raking portion 103 can be unclipped from receiving portion 106 by lifting handle portion 105 away from receiving portion 106. Once raking portion 103 has been unclipped from receiving portion 106, raking portion 103 is pushed by the user over tines 108 (as illustrated in FIG. 2) to dislodge the hair or fur that has accumulated in tines 108 off of the distal end of grooming portion 107. In an embodiment of the invention, a stop portion (not shown) may be placed along grooming portion 107 to ensure that raking portion 103 does not slide too far and fall off of grooming portion 107.

Referring to FIGS. 3 thru 7, preferred shapes and dimensions of grooming portion 107 and tines 108 enable grooming tool 100 to collect the hair or fur that is being brushed and to allow raking portion 103 to clear such hair from tines 108 when necessary. Referring to FIG. 3, grooming portion 107 can have a curvature 315 that generates an arc with a radius between about 0.75 inches to 1.2 inches, with a preferred radius between about 0.90 inches to 1.1 inches and an even more preferred radius of about 1 inch. This curvature 315 allows grooming portion 107 to collect the hair or fur and allows raking portion 103 to push the hair off of tines 108 when tool 100 needs to be cleaned.

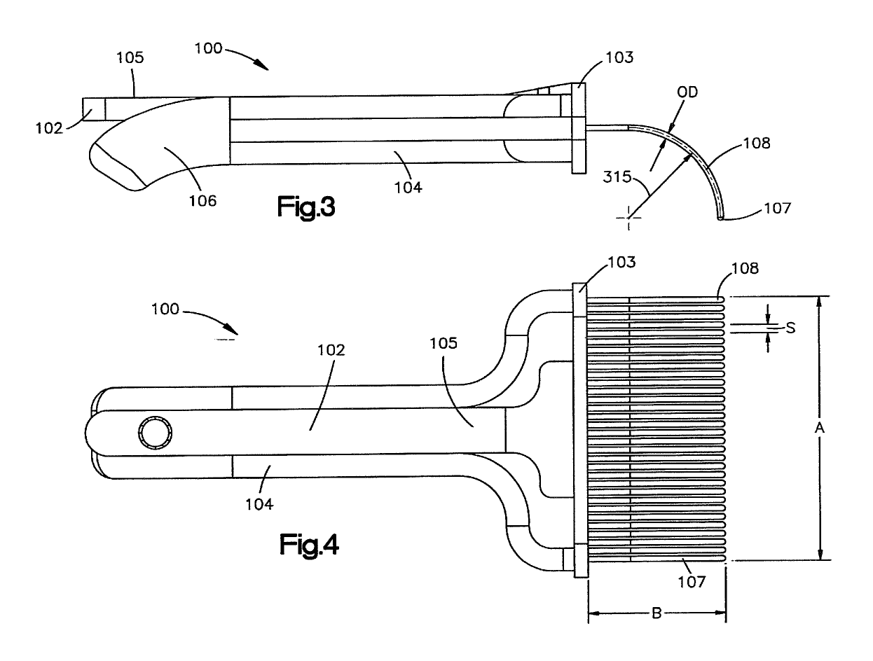

Referring to FIG. 4, the distal end of grooming portion 107 has a width A. In an embodiment of the invention, width A can be in the range from about 2.5 inches to 3.5 inches, more preferably width A is in the range of about 2.8 inches to 3.0 inches and in an even more preferred embodiment, the width A is equal to about 2.9 inches. Similarly in one embodiment of the invention, tines 108 have a length B, which can range from about 1.25 inches to 1.75 inches, more preferably length B is in the range of 1.4 inches and 1.6 inches and in an even more preferred embodiment, length B is equal to about 1.5 inches.

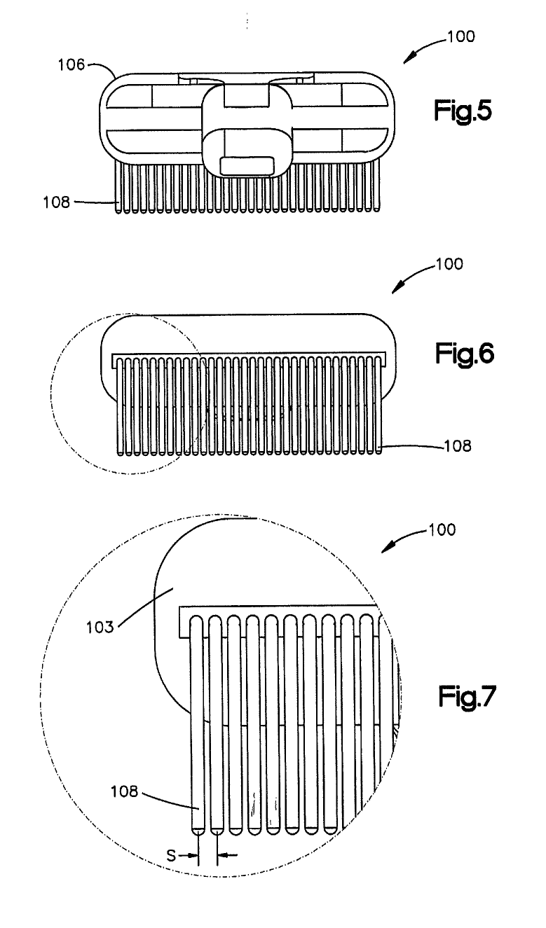

In addition to the overall width of grooming portion 107 and the length of tines 108, the size and spacing of tines 108 from one another is also important to enable the grooming tool 100 to efficiently collect the hair or fur that is then to be pushed or raked off of tines 108 by raking portion 103. Referring to FIGS. 5 and 6, in one embodiment of the invention, grooming portion 107 comprises between about 20 to 40 tines, more preferably, about 25 to 35 tines, and even more preferably about 32 tines 108, which are preferably substantially equally spaced from each other and are each constructed and arranged to be suitable for combing animal hair or fur. Tines 108 are separated from each other by a distance S, which can range between about 0.09 to 0.11 inches, more preferably between about 0.090 to 0.95 inches and most preferably about 0.092 inches when measured between the center point of each tine 108, although other spacing may be used.

Additionally, although described above and shown in FIG. 7 as being equally spaced from each other, tines 108 may have varying spacing in order to accomplish the function of grooming portion 107. It is important that tines 108 are spaced far enough apart from each other to ably brush the animal and not cause any injury, while being close enough to each other to allow the hair or fur to be collected in tines 108 so they do not fall out and can be pushed off when desired by the user using raking portion 103.

Referring to FIG. 3, each tine 108, which is preferably made of stainless steel or some other metal material, has an outer diameter OD between about 0.06 to 0.08 of an inch, more preferably the diameter is between 0.6 to 0.7 of an inch and most preferably about 1/16 (0.0625) of an inch. This diameter allows the tines 108 to brush the animal and detach any dead or loose hairs on the animal without hurting the animal.

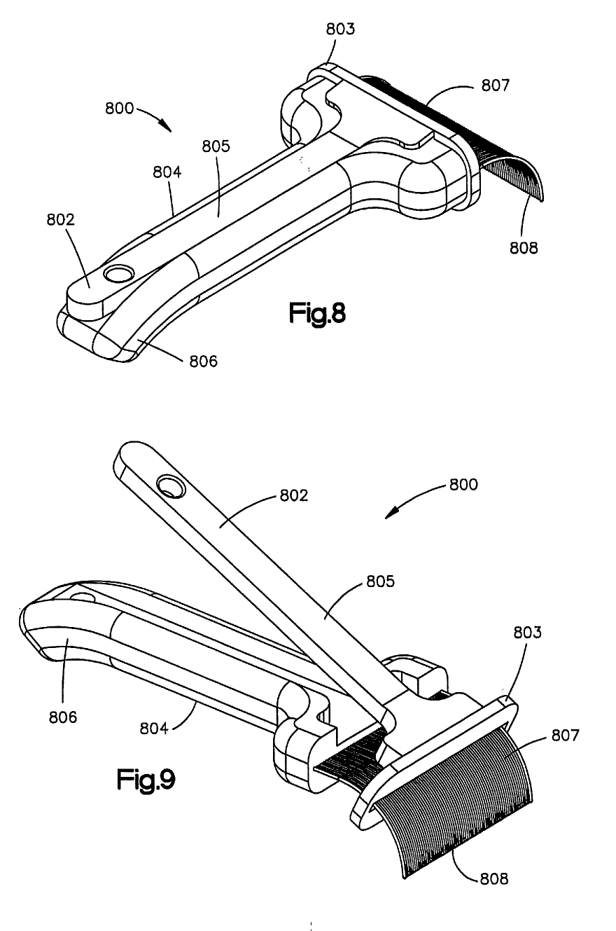

Referring to FIGS. 8 thru 14, a second preferred embodiment of a grooming tool 800 is illustrated. Grooming tool 800 is most preferably used to groom a cat. Referring to FIGS. 8 and 9, grooming tool 800 includes an upper portion 802 and a lower portion 804. Upper portion 802 includes a handle portion 805 and a raking portion 803 that is generally perpendicular to handle portion 805. Lower portion 804 includes a receiving portion 806 and a grooming portion 807. When grooming tool 800 is assembled, handle portion 805 and raking portion 803 mate with receiving portion 806 to create a single tool that allows a user to comb an animal using grooming portion 807. Preferably, raking portion 803 attaches to receiving portion 806 when raking portion 803 is not being used to clear hair or fur from grooming portion 807 as will be discussed in more detail below. In a preferred embodiment of the invention, handle portion 805 and receiving portion 806 are made of a polypropylene material, although other materials as can be appreciated by one with ordinary skill in the art, can be used as well.

In practice, when a user wishes to groom an animal using grooming tool 800, the user grasps grooming tool 800 by handle portion 805 which is mated with receiving portion 806. The user can then groom the animal by combing or brushing grooming portion 807 through the hair or fur of the animal to be groomed. Because of the shape and dimensions of grooming portion 807, as will be discussed in more detail below, the loose hair that is combed becomes lodged within tines 808 of grooming portion 807. Once the user wants to dislodge the hair or fur from tines 808, raking portion 803 is unclipped from receiving portion 806 by lifting handle portion 805 away from receiving portion 806. Once raking portion 803 has been unclipped from receiving portion 806, raking portion 803 is pushed by the user over tines 808 to dislodge the hair or fur that has accumulated in tines 808 off of the distal end of grooming portion 807. In one embodiment of the invention, a stop portion (not shown) may be placed along grooming portion 807 to ensure that raking portion 803 does not fall off of grooming portion 807.

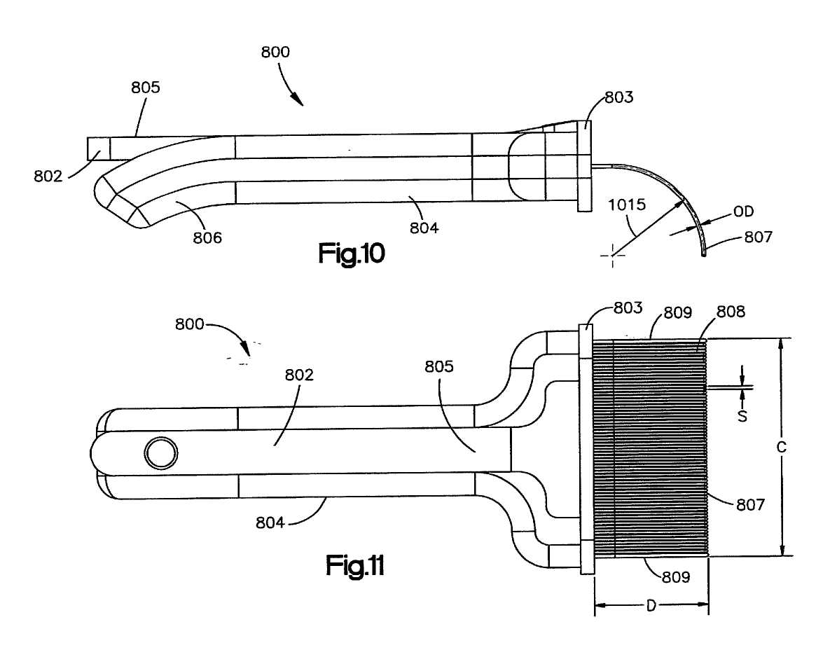

Referring to FIGS. 10 thru 14, the shape and dimensions of grooming portion 807 and tines 808 enable grooming tool 800 to collect the hair or fur that is being combed and to allow raking portion 803 to clear such hair from tines 808 when desired. Referring to FIG. 10, grooming portion 807 has a curvature 1015 that generates an arc with a radius that can be between about 0.8 inches to 1.2 inches, with a preferred radius between about 0.9 inches to 1.1 inches and an even more preferred radius of about 1.0 inch, although this value can fluctuate based upon the overall size of grooming tool 800 and other factors that may affect the geometry of the grooming tool 800. This curvature 1015 helps grooming portion 807 collect the hair or fur and allows raking portion 803 to push such hair off of tines 808 when grooming tool 800 needs to be cleaned.

Referring to FIG. 11, the distal end of grooming portion 807 has a width C. In one embodiment of the invention, width C can range from about 1.5 inches to 3.5 inches, more preferably width C is in the range of about 2 inches to 3 inches and in an even more preferred embodiment, width C is equal to about 2.4 inches. Similarly, in one embodiment of the invention, tines 808 have a length D, which can range from about 1.0 inches to 1.5 inches, more preferably length D is in the range of about 1.2 inch to 1.3 inches and in an even more preferred embodiment, length D is equal to about 1.25 inches.

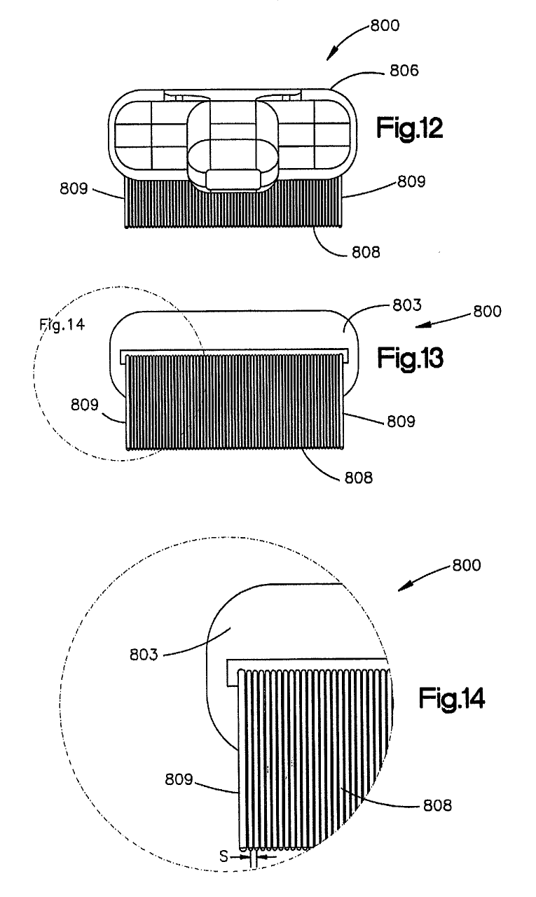

In addition to the overall width of grooming portion 807 and the length of tines 808, the size and spacing of tines 808 from one another is also important to enable grooming tool 800 to efficiently collect the hair or fur that is then to be pushed or raked off of tines 108 by raking portion 803. Referring to FIGS. 12 and 13, in one embodiment of the invention, grooming portion 807 can comprise between about 55 to 85 tines, more preferably, between about 65 to 75 tines, and even more preferably about 70 tines which are preferably equally spaced from each other and are each suitable for brushing or combing animal hair or fur. Tines 808 are separated from each other by a distance S which can range between about 0.03 to 0.04 inches, more preferably between 0.034 and 0.038 inches and most preferably about 0.036 inches when measured between the center point of each tine 808, although other spacing may be used.

It is important that tines 808 are spaced far enough apart from each other to ably brush the animal and not cause any injury, while being close enough to each other to allow the hair or fur to be collected in tines 808 so they do not fall out and can be pushed off when desired by the user using raking portion 803.

Each tine 808, which is preferably made of stainless steel or some other metal material, can have an outer diameter OD between about 0.2 to 0.03 inches, more preferably the diameter is between about 0.022 to 0.028 inches and most preferably about 0.025 inches. This diameter allows tines 808 to comb or brush the animal and detach any dead or loose hairs on the animal without hurting the animal. In one embodiment, end tines 809 may have a slightly larger diameter OD than the other, intermediate tines 808. For example end tines 809 preferably have a diameter between about 0.040 to 0.050 inches, more preferably between about 0.042 to 0.045 inches. In one particularly preferred embodiment, if the diameter of intermediate tines 808 is about 0.025 inches, the diameter of end tines 809 preferably is about 0.043 inches. Among other benefits, this difference in diameter can, in one embodiment, prevent raking portion 803 from sliding off of grooming portion 807.

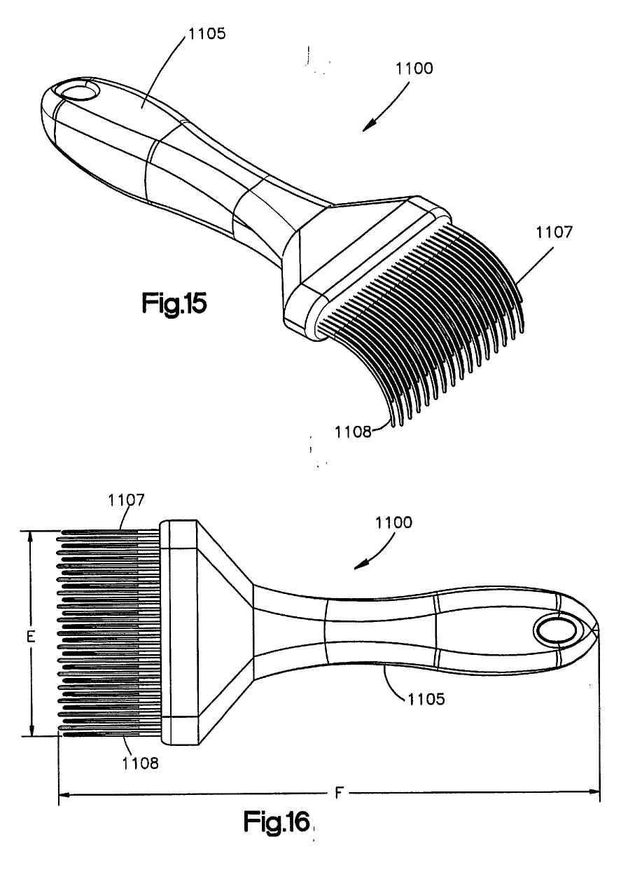

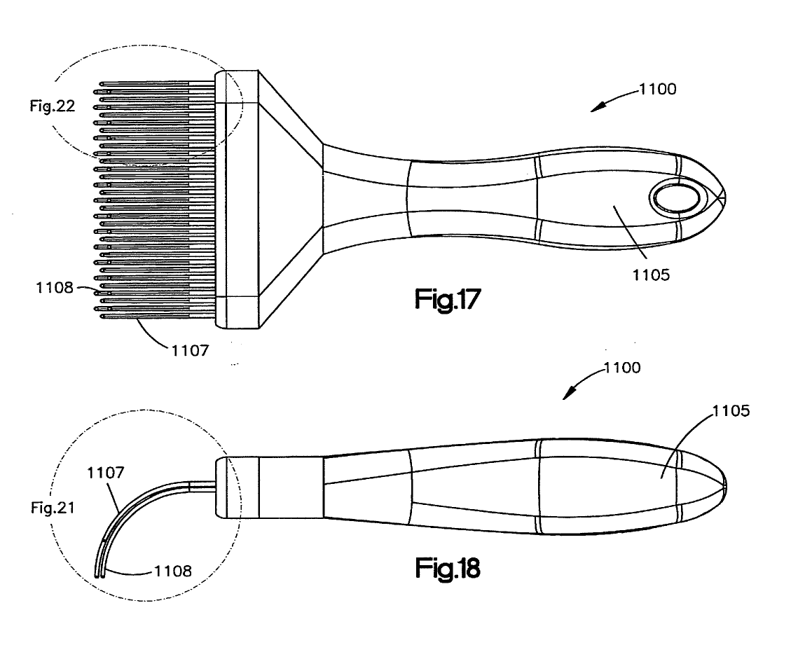

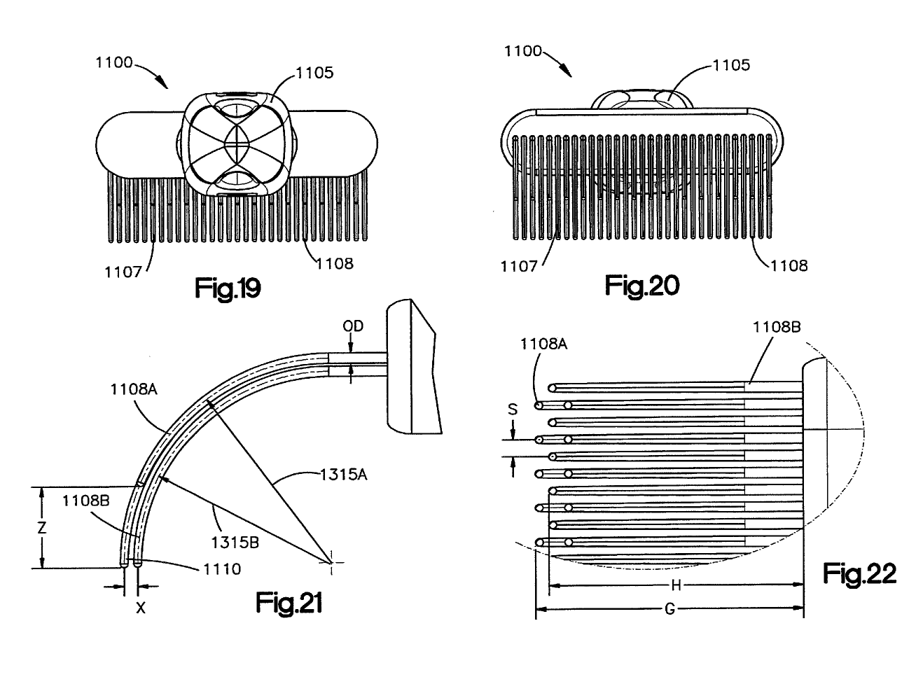

FIGS. 15 thru 23 show a third preferred embodiment of a grooming tool 1100 and the components thereof in accordance with an embodiment of the present invention which is most preferably used for a dog. Grooming tool 1100 includes a handle portion 1105 and a grooming portion 1107. In a preferred embodiment of the invention, handle portion 1105 is made of a polypropylene material, although other materials, as can be appreciated by one with ordinary skill in the art, can be used as well.

Referring to FIG. 16, the distal end of grooming portion 1107 has a width E. In one embodiment, the width E can be in the range from about 2.5 inches to 3.5 inches, more preferably width E is in the range of about 2.6 inches to 2.9 inches and in an even more preferred embodiment, the width E is equal to about 2.740 inches. In addition, grooming tool 1100 preferably has an overall length F which can be approximately 7.25 inches, although as can be appreciated by one with ordinary skill in the art, other lengths can be used as well.

In practice when a user wishes to groom an animal using grooming tool 1100, the user grasps grooming tool 1100 by handle portion 1105. The user can then groom the animal by combing or brushing grooming portion 1107 through the hair or fur of the animal to be groomed. Because of the shape and dimensions of grooming portion 1107, as will be discussed in more detail below, the hair that is combed becomes lodged within tines 1108 of grooming portion 1107. Once the user wants to dislodge the hair or fur from tines 108, the user may simply remove the collected fur from grooming portion 1107.

The shape and dimensions of grooming portion 1107 and tines 1108 enable grooming tool 1100 to collect the hair or fur that is being combed or brushed. As best shown in FIGS. 21 thru 23, grooming portion 1107 preferably includes a first or upper row of tines 1108A and a second or lower row of tines 1108B, although it is envisioned that more than two rows of tines 1108 may be incorporated. The two rows of tines 1108A, 1108B are vertically separated from each other by a distance X which can range between about 0.06 to 0.09 inches, more preferably about between about 0.07 to 0.08 inches and most preferably about 0.074 inches when measured between the center point of tines 1108A and 1108B, although other spacing may be used. In addition, the two rows of tines 1108A, 1108B preferably have a different radius of curvature. That is, the first or upper row of tines 1108A have a curvature 1315A that generates an arc with a radius that can be between about 0.75 inches to 1.2 inches, with a preferred radius between about 1.0 inches to 1.2 inches, and an even more preferred radius of about 1.087 inch while the second or lower row of tines 1108B have a curvature 1315B that generates an arc that can have a radius between about 0.75 inches to 1.2 inches, with a preferred radius between about 0.9 inches to 1.1 inches, and an even more preferred radius of about 1.0 inch.

Furthermore, each of the first and second rows of tines 1108A, 1108B preferably include alternating tines of varying lengths. That is, referring to FIGS. 19 thru 23, each of the first and second row of tines 1108A, 1108B preferably includes alternating first and second tines, wherein the first tines have a longer length and the second tines have a shorter length. Thus, each of the first and second row of tines 1108A, 1108B preferably includes alternating longer and shorter length tines. More preferably, the longer first tines and the shorter second tines in the first row of tines 1108A alternate as compared to the longer first tines and the shorter second tines in the second row of tines 1108B. As such, grooming portion 1107 preferably includes first and second rows of tines 1108A, 1108B vertically spaced from one another wherein the first and second row of tines each include alternating first and second tines and wherein the first tines in the first row alternate with the first tines in the second row and the second tines in the first row alternate with the second tines in the second row.

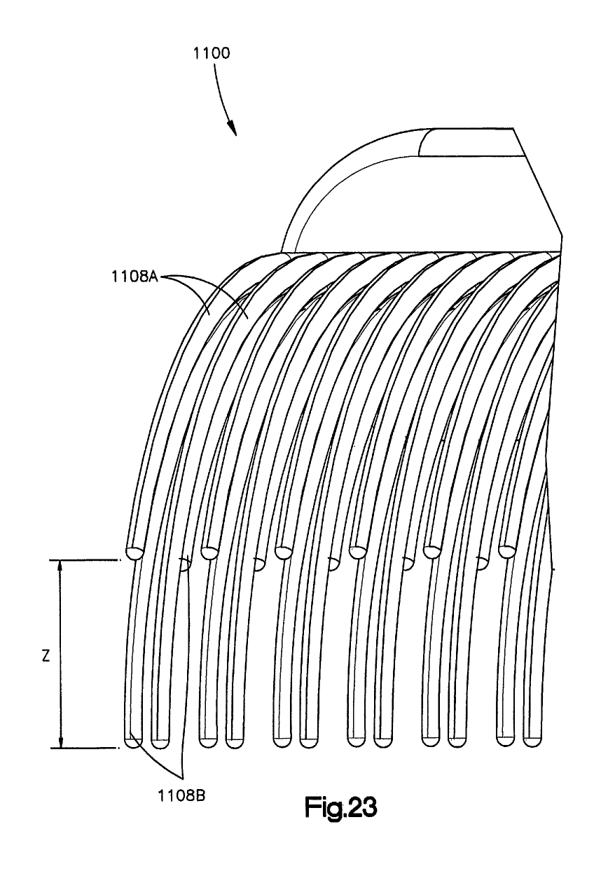

Referring to FIG. 22, the longer first tines in the first or upper row of tines 1108A have a length G as measured from the handle portion 1105, the length G can be between about 1.25 inch to 1.75 inches, with a preferred length between 1.3 inches to 1.5 inches and an even more preferred length of about 1.4 inch. Similarly, the longer first tines in the second or lower row of tines 1108B have a length H as measured from the handle portion 1105, the length H can be between about 1.0 inch to 1.5 inches, with a preferred length between about 1.1 inches to 1.4 inches and an even more preferred length of about 1.27 inch. In addition, referring to FIGS. 21 and 23, the distal end of the longer first tines in the first or upper row of tines 1108A preferably extends beyond the distal end of the shorter second tines in the first or upper row of tines 1108B by a distance Z, which preferably has a length that can be between about 0.25 to 0.60 of an inch, more preferably between about 0.45 to 0.50 of an inch and most preferably about 0.43 of an inch.

Furthermore, the size and spacing of tines 1108 from one another is also important to enable grooming tool 1100 to efficiently collect the hair or fur. In one embodiment, each row of tines 1108A, 1108B can comprise between about 20 to 40 tines, more preferably, about 25 to 35 tines, and even more preferably about 31 tines 1108A, 1108B, which are preferably substantially equally spaced from each other and are each capable of combing animal hair or fur. Preferably, tines 1108 are separated from each other by a distance S which can range between about 0.08 to 0.11 inches, more preferably between about 0.09 to 0.11 inches and most preferably about 0.1 inches when measured between the center point of each tine 1108, although other spacing may be used.

Additionally, although described above and generally shown as being equally spaced from each other, tines 1108 may have varying spacing in order to accomplish the function of grooming portion 1107. It is important that tines 1108 are spaced far enough apart from each other to ably brush the animal and not cause any injury, while being close enough to each other to allow the hair or fur to be collected in tines 1108 so they do not fall out.

Each tine 1108, which is preferably made of stainless steel or some other metal material, preferably has a tapered outer diameter. That is, referring to FIG. 21, each tine 1108 preferably has an outer diameter OD at the proximal end, adjacent to handle portion 1105, that can be between about 0.055 and 0.07 of an inch, more preferably the diameter is between about 0.055 to 0.65 of an inch and most preferably about 0.060 of an inch. Each tine 1108 preferably has an outer diameter OD at the distal end which can be of between about 0.035 to 0.050 of an inch, more preferably the diameter is between about 0.035 to 0.045 of an inch and most preferably about 0.040 of an inch. Providing such diameters allows tines 1108 to brush the animal and detach any dead or loose hairs on the animal without hurting the animal. In addition, tips 1110 of tines 1108 are preferably hemispherical. However, it should be understood that while tines 1108 have been described as having a tapered diameter and a hemispherical tip, it is important to note that the tines 1108 may have other shapes including being non-tapered and having non-hemispherical tips.

By incorporating multiple rows of vertically offset tines 1108 having different radius of curvatures and different lengths of tines 1108, the grooming tool 1100 produces the optimal deshedding of the undercoat while not disturbing the top coat of the pet.

The scope of the present invention covers conventionally known and features of those variations and modifications through the components described herein as would be understood by those skilled in the art. It is the intention, therefore, not to limited by the details of the particular embodiments discussed above, but it is intended to cover modifications within the spirit and scope of the present invention.

What is claimed is:

1. A grooming tool for grooming an animal, the tool comprising:
a handle portion, and
a grooming portion coupled to an end of the handle portion, the grooming portion including a plurality of tines, the plurality of tines being arranged in first and second rows such that the first row of tines is vertically offset from the second row of tines by a distance X;
the distance X separating the first and second rows of tines is between 0.07 and 0.08 inches;
each of the tines in the first row of tines has a first radius of curvature and each of the tines in the second row of tines has a second radius of curvature, the second radius of curvature being smaller than the first radius of curvature;
the first radius of curvature is about 1.0 to 1.2 inches and the second radius of curvature is about 0.9 to 1.1 inches;
each of the tines is separated by a distance S of between about 0.09 inches to 0.11 inches; and
the tines are constructed and arranged to trap loose pet hair or fur therein as the tines are moved through the animal's hair or fur.

2. The grooming tool of claim 1, wherein the distance X separating the first and second rows of tines is about 0.074 inches.

3. The grooming tool of claim 1, wherein each of the first and second row of tines include alternating first and second tines, wherein the first tines have a first length and the second tines have a second length, the second length being different that the first length.

4. The grooming tool of claim 3, wherein the first and second tines in the first row alternate with respect to the first and second tines in the second row.

5. The grooming tool of claim 1, wherein the grooming portion has a width between 2.5 inches and 3.5 inches.

6. The grooming tool of claim 1, wherein the grooming tool includes between 20 and 40 tines.

7. The grooming tool of claim 1, wherein the grooming tool includes between 25 and 35 tines.

8. The grooming tool of claim 1, wherein each of the tines includes a tapered outer diameter.

9. The grooming tool of claim 1, wherein each of the tines includes a hemispherical tip.

10. A grooming tool for grooming an animal, the tool comprising:
a handle portion, and
a grooming portion coupled to an end of the handle portion, the grooming portion including a plurality of tines arranged in first and second rows such that the first row of tines is vertically offset from the second row of tines by a distance X, each of the first and second row of tines include alternating first and second tines, wherein the first tines have a first length and the second tines have a second length, the second length being different that the first length.

11. The grooming tool of claim 10, wherein the first and second tines in the first row alternate with respect to the first and second tines in the second row.

12. The grooming tool of claim 11, wherein each of the tines includes a tapered outer diameter.

13. The grooming tool of claim 11, wherein each of the tines includes a hemispherical tip.

14. The grooming tool of claim 10, wherein each of the tines in the first row of tines has a first radius of curvature and each of the tines in the second row of tines has a second radius of curvature, the second radius of curvature being smaller than the first radius of curvature.

15. The grooming tool of claim 14, wherein the first radius of curvature is about 1 to 1.2 inches while the second radius of curvature is about 0.9 to 1.1 inches.
